(19) United States
(12) Patent Application Publication
(10) Pub. No.: US 2018/0313547 A1
(43) Pub. Date: Nov. 1, 2018

(54) COMPONENT, ARRANGEMENT OF COMPONENTS AND SYSTEM AND THE USE THEREOF

(71) Applicant: ANDREAS REICHLE, MUHLINGEN (DE)

(72) Inventor: ANDREAS REICHLE, MUHLINGEN (DE)

(21) Appl. No.: 15/565,509

(22) PCT Filed: Apr. 8, 2016
(86) PCT No.: PCT/DE2016/100167

§ 371 Date: Oct. 10, 2017

(30) Foreign Application Priority Data
Apr. 14, 2015 (DE) 102015105708.5

(51) Int. Cl. F24D 3/00; F24D 3/14; F24S 10/75; F24S 20/66; F24S 70/60; H02S 40/44

(52) U.S. Cl. CPC F24D 3/005; F24D 3/142; F24S 10/753; H02S 20/26; F24S 70/60; H02S 40/44; F24S 20/66

(57) ABSTRACT

A component (1, 7, 10, 13, 17, 21, 25, 29, 35) has a profiled front face (4, 8, 11, 16, 23, 26, 30, 41) and a rear face (5, 24, 34) and at least one fluid line (6, 9, 12, 14, 19, 27, 31, 38, 40). The component (1, 7, 10, 13, 17, 21, 25, 29, 35) is designed to allow a fluid present in the fluid line (6, 9, 12, 14, 19, 27, 31, 38, 40) to heat up when the front face (4, 8, 11, 16, 23, 26, 30, 41) is irradiated with sunlight.

The present invention relates to a structural element having a shaped front face and rear face, a structural element arrangement with such structural elements, a system with such a structural element, or a structural element arrangement, as well as uses thereof.

A wall or ceiling cladding with a suspended ceiling of corrugated metal plates is known, for example, from G 94 01 705 U1. In the case of this wall or ceiling cladding, cooling tubes run on a rear side or upper side of the metal plates facing away from the visible side of the metal plates, wherein each are laid in the form of a wave or fold protruding towards the visible side and possibly in contact with the metal plate.

DE 20 2007 017 185 U1 discloses a surface heating device or surface cooling device which has a prefabricated support plate with channels for heating or cooling elements, as well as a heat insulation device. In this case, the support plate is designed to be flat. Furthermore, the device for plating is provided with a loam panel which covers the heating or cooling elements.

It is the object of the present invention to provide a multifunctional structural element, a multifunctional structural element arrangement, a multifunctional system, and also applications for the same.

This object is achieved by the structural element with the features of claim 1, by the structural element arrangement with the features of claim 9, by the system with the features of claim 10, and by the uses with the features of claim 12. Preferred embodiments are the subject matter of the dependent claims.

In the subject matter of the present invention, a fluid which is located in the fluid line and which flows through the fluid line, for example, is heated by sunlight acting upon the front side of the structural element. The fluid may, in principle, be any desired gaseous or liquid fluid. In general, the fluid line may be flowed through, or is flowed through, by any liquid or gaseous fluid. If the fluid is water, for example, hot water may be produced by means of the structural element of the present invention. However, energy or heat energy may also be obtained from the heated fluid by means of a heat exchanger connected downstream of the structural element in a flow circuit of the fluid. As a result of the property of the structural element, a fluid located in the fluid line is heated when sunlight acts upon the front side, wherein further interactions occur between the fluid line, or between a fluid flowing through the fluid line and the surroundings of the structural element, which opens up various possible applications of the structural element. If the structural element is arranged, for example, in an interior space, then a fluid may be provided to flow through the fluid line, wherein the fluid has a higher temperature than the surroundings of the structural element. In this case, heat energy from the fluid to the surroundings, e.g. the ambient air, may be used to heat the interior space in this way. If, on the other hand, fluid is provided to flow through the fluid line but has a lower temperature than the surroundings of the structural element, then the fluid will absorb heat energy from the surroundings of the structural element, as a result of which the interior space will cool. Depending on the temperature of the fluid flowing through the fluid line with respect to the surroundings of the structural element, the structural element may be used both for heating and for cooling spaces. Thus, the structural element according to the invention may be used multifunctionally and may be used, in particular, for generating hot water or for heating a space or for cooling a space.

Preferably, the structural element is designed as a module, or as a module which may be transported autonomously. The structural element according to the invention may, in particular, be a cladding element for at least partial cladding of a surface, for example a wall surface of an outer or inner wall. In this case, the rear side may be provided for the at least partial application to the surface, wherein the front face of the structural element faces away from the surface when the rear side is at least partially applied to the surface. A structural element of this type may be used instead of, or in combination with, known cladding elements for the cladding of surfaces because, as a result of the profile on the front side of the structural element, the fluid line may be provided without a major negative impact on the aesthetic appearance of the structural element. Thus, the optical appearance of surfaces or objects provided with the structural element according to the present invention, are not negatively affected, unlike surfaces or objects clad with conventional devices. Furthermore, the structural element may have a flat rear side if the structural element is provided for cladding a flat surface, or it may have a curved, and in particular concavely-curved rear side if the structural element is provided for cladding a curved surface. Accordingly, the structural element as such, may be essentially plate-shaped or comprise the shape of a curved or convex plate, or the structural element itself may be curved or convex. Furthermore, the rear side may be shaped like the front side.

The fluid line may, for example, be arranged on the front side. In particular, it may be simply set up on the front side of the structural element, or at least partially accommodated in a corresponding, for example, channel-shaped recess, which is formed on the front side of the structural element. If the fluid line is arranged on the front side and not inside the structural element or on its rear side, and the structural element designed as a cladding element is in the form of a flat surface-covering state, the fluid line may be uncovered or exposed since the front side of the structural element faces away from the cladding surface. If the cladding surface is an outer surface of a wall and the structural element is exposed to solar radiation, the uncovered or exposed, or uncovered exposed, fluid line is also exposed to the solar radiation, and the fluid flowing through the fluid line is heated by the incident solar radiation. However, the fluid line does not necessarily have to be exposed on the front side, provided that the fluid is heated within the fluid line through incident sun radiation. If a wall is located between the front side and the fluid line, its thickness should, for this reason, correspond at most to twice, or a unit, or a half, or a quarter, or a tenth of the wall thickness of the fluid line.

The structural element may also have a plurality of fluid lines, which are provided for respectively separate fluid circuits. Furthermore, the fluid line may be at least partially or completely transparent or opaque.

Advantageously, at least in some regions, the front face and/or the fluid line is arranged to absorb or reflect infrared radiation and/or solar radiation, or the front face and/or the fluid line is at least partially covered with a photovoltaic layer. Regions absorbing infrared radiation and/or solar radiation favor the heating of the fluid in the fluid line and therefore increase efficiency in hot water generation and energy generation, as well as in the cooling of spaces by means of the structural element. On the other hand, regions reflecting infrared radiation and/or solar radiation are preferred when the structural element is used for heating spaces. If the structural element is provided with a photovoltaic layer, the structural element may also be used for generating current. The photovoltaic layer may, for example, be a known foil, which converts incident radiation energy into electrical energy photovoltaicaly. If the photovoltaic layer is applied to the fluid line, or is in contact therewith, the layer may advantageously be cooled by the fluid flowing through the fluid line, as a result of which the efficiency of the photovoltaic layer is significantly increased compared to an uncooled photovoltaic layer. A further advantage of such an embodiment is that only the section of the fluid line or the front side provided with the photovoltaic layer, reflects sunlight, whereas conventional solar panels reflect sunlight over their entire surface and, thus, not only have a negative effect on their surroundings, but may be dangerous to traffic mainly because of the glare effect on vehicle drivers. Alternatively, an air gap may be formed between the fluid line and the photovoltaic layer, which may act as an additional fluid line for the air flowing through the air gap, wherein the air is provided to cool the photovoltaic layer.

The structural element is preferably designed with at least one heat insulation material arranged between the front and the rear side. In this case, the rear side of the structural element may, in particular, be in the form of a surface of the heat-insulating material. The heat-insulating material may in particular be designed as a heat-insulating layer. Such a structural element advantageously contributes to the thermal insulation of the surface covered with the structural element. In particular, the formation of condensation may be avoided by means of such a heat-insulating material. The heat-insulating material may, for example, consist of a polyurethane foam or glass or stone wool. Particularly preferred, however, are hemp fibers as a heat insulation material, since hemp fibers, unlike, for example, glass wool, are degradable or recyclable and are harmless from a health point of view as well as also having high drying capability. If the operation of the structural element or the flow of fluid through the fluid line leads to the formation of condensation, because the structural element has, for example, no heat-insulating material or thermal insulation layer, the structural element may also be advantageously used to obtain water or drinking water if the resulting condensation is collected.

In principle, the structural element may be made of a wide variety of materials. For example, the structural element may be made completely or partially from one or more metals such as aluminum or steel. In particular, the profiled front side of the structural element may, for example, consist of an aluminum plate, which is characterized by good heat conduction properties. However, a preferred embodiment of the structural element has a water vapor diffusion permeability at least in some regions and/or it is sound-proof at least in some regions. Advantageously, an at least partially water vapor diffusion-permeable structural element has an effect on the humidity of rooms whose walls are clad with one or more such structural elements. As materials having high water vapor diffusion permeability, natural grains or the already mentioned hemp fibers are preferred, as are materials with similar properties. For sound insulation, however, the structural element may comprise a perforated plate.

In general, a cross-sectional profile of the structural element may have common profile shapes such as arched shapes, triangular shapes, rectangular shapes or trapezoidal shapes. For example, the front side of the structural element may be formed by an ordinary corrugated sheet. Electrical cables may be advantageously passed through the structural element if the structural element is passable at least in places. However, preference is given to an embodiment of the structural element in which the front side has a cross-sectional profile with variously protruding sections. For example, the cross-sectional profile may have a first group of protruding sections and a second group of protruding sections, wherein the sections of the second group do not protrude as far as the sections of the first group, and wherein sections of the first group alternate with sections of the second group. Such designs may be characterized by an increased environmental resistance to hail, storms, wind, thunderstorms or lightning strikes. In particular, the fluid line may be protected from hail with such cross-sectional profiles, while whistling noises caused by wind in conventional structural elements may be avoided.

In a further preferred embodiment of the structural element, the front side has, at least in some regions, a functional surface structure or a dirt-repellent coating. Such a dirt-repellent coating may be implemented, for example, by means of a fluorinated coating of silica glass with a spherical nanostructure.

The structural element according to the invention may be part of a building or a vehicle. For example, the structural element of the present invention enables the surface of a wall or a ceiling or a floor of a building or a vehicle to be at least partially or completely clad. For this purpose, the structural element may be detachably or non-detachably connected to the surface, or attached to the surface. Thus, the structural element may be glued or screwed to the surface, or attached to the surface by means of a snap-in connection. The building may be any building such as a residential house, a factory building, a warehouse, a hospital, a church or a public building. Likewise, the vehicle may be any land, air, water, underwater vehicle, or spacecraft.

In the case of a structural element arrangement according to the invention with two structural elements, where the rear sides face one another, the rear sides may at least partially abut one another. Preferably, however, the rear sides delimit a cavity, which may be formed, for example, by at least one recess in at least one of the rear sides, or is formed simply by the fact that the rear sides are spaced apart from each other. This cavity may be advantageously provided to guide or receive electrical cables.

If the structural element or structural element arrangement according to the present invention is part of a system, the system may comprise at least one pumping device to pump a fluid through the fluid line. By means of the pumping device, a flow of the fluid through the fluid line may be effected or maintained. The system may be, in particular, a hot water recovery system, a heating system, a cooling system, an air conditioning system or a sprinkler system. Accordingly, the system may comprise at least one fluid and/or at least one control unit for controlling the system or structural elements of the system and/or at least one fluid reservoir for storing the fluid and/or at least one heat exchanger and/or at least one expansion vessel and/or the at least one safety element and/or at least one regulating device and/or at least one sensor such as, for example, a pressure or temperature sensor for detecting the pressure or the temperature of the fluid, and/or at least one valve and/or at least one collecting container for condensation, and/or at least one smoke detector.

If the system is, for example, a sprinkler system, the system may advantageously comprise, in addition to a control unit and a non-combustible fluid, a smoke detector as well as at least one external valve, which may be provided, for example, on the fluid line on the front side of the structural element. As soon as smoke is detected by the smoke detector, the control unit opens the external valve in order to spray fluid from the fluid line in the vicinity of the structural element to extinguish a possible fire.

The invention is explained in more detail below with reference to preferred exemplary embodiments.

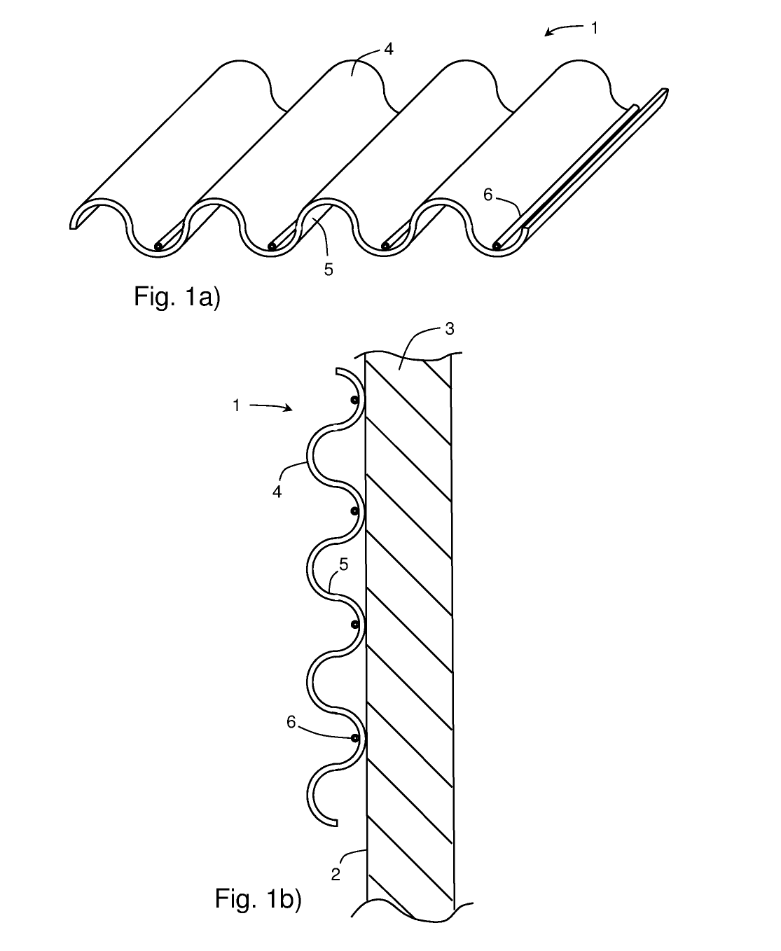

FIG. 1a) shows a spatial representation of a structural element;

FIG. 1b) shows a cross-section through the structural element of FIG. 1a) in a state covering a surface;

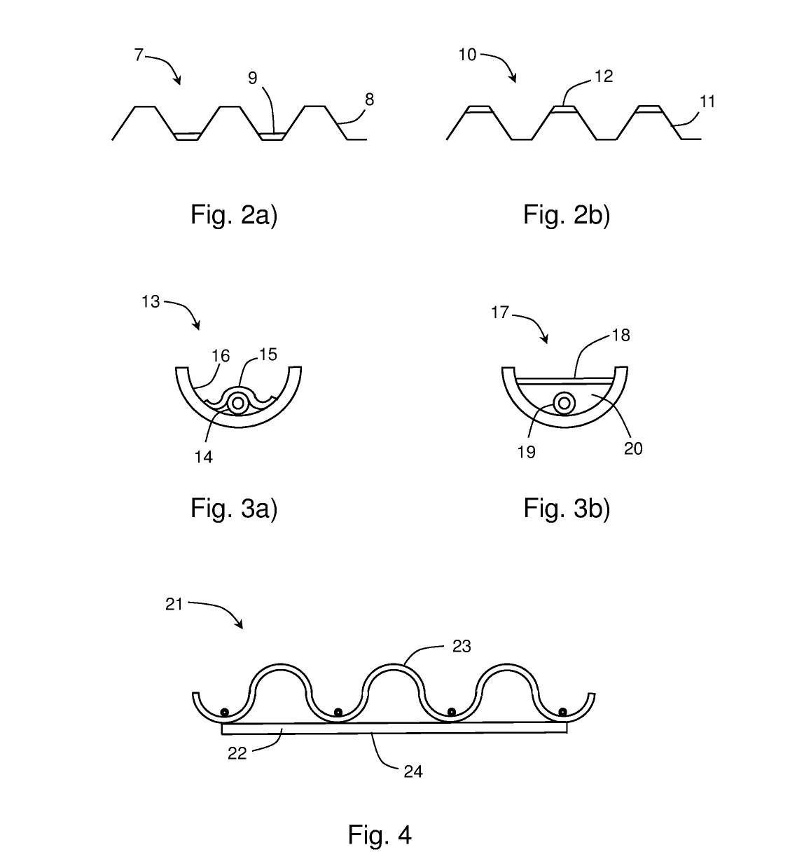

FIG. 2a) shows a schematic cross-section through a further structural element;

FIG. 2b) shows a schematic cross-section through a further structural element;

FIG. 3a) shows a detailed view of a structural element with a photovoltaic layer;

FIG. 3b) shows a detailed view of a further structural element with a photovoltaic layer;

FIG. 4 shows a cross-section through a structural element with a thermal insulation layer;

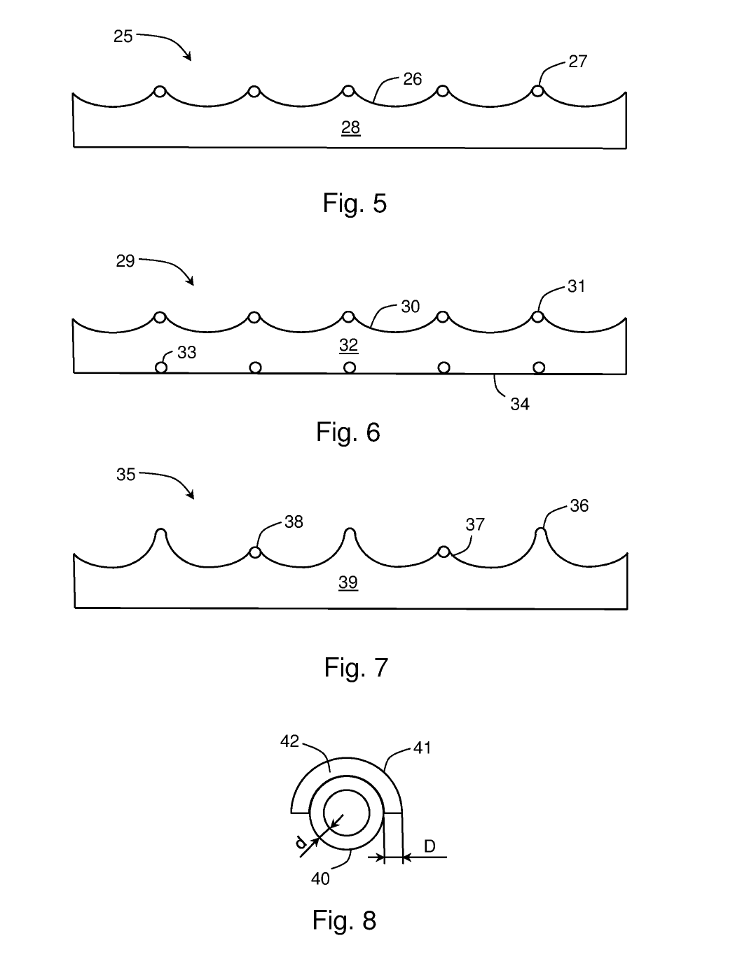

FIG. 5 shows a cross-section through a structural element;

FIG. 6 shows a cross-section through a structural element;

FIG. 7 shows a cross-section through a structural element;

FIG. 8 shows a detailed view of a structural element in which a wall is provided between the front side and the fluid line.

A simple embodiment of a structural element 1 is shown in the cross-section in FIG. 1a) in a spatial view and in FIG. 1b). The structural element 1 is provided for cladding a planar face or surface 2 of a wall 3 and has a front side 4 and a rear side 5. The front side 4 shows a corrugated cross-sectional profile with periodically-repeating symmetrical, arcuate shaped sections. A corresponding cross-sectional profile is also shown for the rear side 5. A respective fluid line 6 with a round cross-section extends in each case between two arc-shaped sections. In the state of the structural element 1 shown in FIG. 1b), which covers the surface 2, the structural element 1 with parts of the rear side 5 rests against the surface 2. In other words, the rear side 5 faces the surface 2, while the front side 4 faces away from the surface 2. Since the front side 4 faces away from the surface 2, the fluid lines 6 arranged on the front side 4 are uncovered or exposed, or they are also arranged to face away from the surface 2 on the structural element 1.

If one end of the fluid lines 6 is connected to a supply line (not shown) for a fluid, such as for example water, and the opposite end is connected to the fluid lines 6 for the fluid, the fluid lines 6 may be traversed by the fluid. Depending on whether the ambient temperature of the structural element 1 is greater or smaller than the temperature of the fluid flowing through the fluid lines 6, heat is absorbed or emitted by the fluid from/to the surroundings. Accordingly, the surroundings of the structural element 1 are either cooled or heated. If the wall 3 or the structural element 1 is exposed to solar radiation, the fluid within the fluid lines 6 is heated by the incident solar radiation. The heated fluid may be led via the discharge lines to a heat exchanger (not shown in the figures), which removes heat energy from the heated fluid. However, the heated fluid may also be guided to fluid lines of another structural element which is arranged on the wall surface of an interior space in order to heat this interior space. If the fluid is water, the water heated in the manner described may also be used as hot water.

Instead of providing a fluid line 6 between each arcuate shaped section as in the structural element 1 illustrated in FIGS. 1a) and 1b), in the case of other embodiments of the structural element more or fewer or only one fluid line 6 may also be arranged on the front side 4 of the structural element 1. These may also be arranged between two adjacent arcuate shaped sections or tops of the arcuate shaped sections, or some fluid lines between adjacent shaped sections and other fluid lines may be arranged at tops of shaped sections. Furthermore, the fluid lines 6 may be connected successively to each other in a communicating manner, so that the structural element 1 effectively has a single fluid line extending or meandering over the entire structural element 1.

A plurality of identical structural elements 1 may be arranged above and below and next to the described structural element 1 for the complete covering of the surface 2. In this case, fluid lines of adjacent structural elements 1 may be connected to one another in a communicating manner in order to enable a fluid to pass from, for example, the fluid line 6 of the structural element 1 into the fluid line of an adjacent structural element. In this way, it is possible to cover or clad the entire surface 2 with a plurality of identical structural elements 1, thereby providing one or more flow paths for the fluid extending over a plurality of structural elements 1.

If the structural element 1 is sufficiently stiff, it may also be set up to be self-supporting and, for example, to form a wall itself instead of cladding a wall. Or the structural element may be attached to one or more pillars. If the wall clad by the structural element is a curved wall, the structural element may be appropriately curved in order to adapt itself to the curvature of the wall.

Instead of the cross-sectional profile with arcuate shaped sections, as is shown for the structural element 1 in FIGS. 1a) and 1b), the front side may also have differently shaped cross-sectional profiles. For example, FIG. 2 shows a cross-section through a structural element 7, the front side 8 of which has a cross-sectional profile with periodically-repeating trapezoidal shaped sections. Flat fluid lines 9 are arranged between two adjacent trapezoidal shaped sections on the front side 8. A similar structural element 10, which likewise has a front side 11 with a cross-sectional profile with periodically-repeating trapezoidal shape sections, is shown in FIG. 2b). In the device 10, however, fluid lines 12 are not arranged between two adjacent trapezoidal shaped sections but at the top of each of the trapezoidal shaped sections.

FIG. 3a) shows a detailed view of a structural element 13 with arcuate shaped sections, between which, as in the case of the structural element 1 shown in FIGS. 1a) and 1b), fluid lines 14 may be arranged in a circular cross-section. The fluid line 14 shown in FIG. 3a) is covered by a photovoltaic layer 15 which extends on both sides of the fluid line 14 as well as over a part of the front side 16 of the structural element 13. When the structural element 13 is irradiated with sunlight, therefore, not only the fluid in the fluid line 14 is heated, but electrical current is also generated by the photovoltaic layer 15. Due to the direct contact with the fluid line 14, heat is dissipated from the photovoltaic layer 15 by the fluid. The photovoltaic layer 15 is thereby cooled, thereby increasing its efficiency. In an alternative embodiment, the photovoltaic layer 15 may also cover or clad the entire structural element 13.

FIG. 3b) shows a similar structural element 17 with a photovoltaic layer 18, which is not in contact with the fluid line 19 in contrast to the structural element 13 shown in FIG. 3a. Instead, the photovoltaic layer 18 is spaced from the fluid line 19 in FIG. 3b), so that an air channel 20 is formed between the photovoltaic layer 18 and the fluid line 19. Air that flows through this air channel 20 contributes to the cooling of the photovoltaic layer 18. Again, in an alternative embodiment, the photovoltaic layer 18 may cover or clad the entire structural element 17. During cooling, the air channel 20 may be advantageously used to obtain water or condensation.

A structural element 21 with a thermal insulation layer 22 is shown in FIG. 4. The front side 23 of this structural element 21 essentially corresponds to that of the structural element 1 illustrated in FIGS. 1a) and 1b). However, in the structural element 21, the rear side 24 coincides with a side of the parallelepiped thermal insulation layer 22 which is thus arranged between the rear side 24 of the structural element 21 and the front side 23 thereof. The heat insulation layer 22 is a layer of hemp fibers because hemp fibers are characterized not only by good thermal insulation properties but also by high water vapor diffusion permeability.

A cross-section through a further structural element 25 is shown in FIG. 5. In the structural element 25, the cross-sectional profile is shaped like a wave on the front side 26 thereof. Fluid lines 27 are arranged at the tops of the corrugations. Unlike the structural element 21 comprising the insulation layer 22, the structural element 25 is completely filled by a thermal insulation material 28. Thus, no voids remain within the structural element 25, in which condensation could build up or accumulate.

A very similar structural element 29 is shown in FIG. 6. The structural element 29 also has a cross-sectional profile with a wave-like front face 30 and fluid lines 31 arranged at the tops of the waves. Furthermore, the structural element 29 is also completely filled by a thermal insulation material 32. However, the structural element 29 also has further fluid lines 33, which are arranged adjacent to the rear side 34 of the structural element 29, or in a rear end section of the structural element 29. By means of the fluid lines 31 and the fluid lines 34 two separate fluid circuits may be implemented. Or, a fluid which is heated upon exposure to the front surface 30 in the fluid lines 31 may then be guided into the fluid lines 33 where it may deliver the previously-absorbed heat to the surroundings of the rear side 34.

A further structural element 35 is shown in FIG. 7. The cross-sectional profile of the structural element 35 is characterized in that it has sections 36 which protrude further than the intermediate sections 37, and which are arranged at the tops of which fluid lines 38. Thus, the fluid lines 38 of the further protruding sections 36 are protected from environmental influences. As in the previous examples, the device 35 is also filled with a thermal insulation material 39.

In the examples described above, the fluid lines of the structural elements need not be uncovered or exposed at all. Rather, a wall or layer may also be present between the front sides of the structural elements and their fluid lines. FIG. 8 shows a detailed view of a structural element with a fluid line 40, which is covered by a wall 42 towards the front side 41 of the structural element. The wall 42 has a thickness D, while the fluid line has a wall thickness d. In order to ensure that fluid which is located within the fluid line 40 is heated when it is irradiated with solar radiation on the front side 41, the thickness D of the wall 42 should not be too great. The thinner the thickness D of the wall 42 relative to the wall thickness d of the fluid line 40, the better the fluid in the fluid line 40 is heated. Therefore, it is preferable that the thickness D of the wall 42 is at most double or a unit, or a half, or one quarter, or one-tenth of the wall thickness d of the fluid line 40.

In particular, the structural elements 21, 25, 29 and 35 are suitable, owing to their flat backs, to form a structural element arrangement in which two of these structural elements 21, 25, 29 and 35 are arranged with their rear sides facing each other, or even adjacent to one another. In the case of such a structural element arrangement, the front sides of the respective structural elements 21, 25, 29 and 35 forming the structural element arrangement, are opposite each other or face away from one another, so that the resulting structural element arrangement has two opposing sides with respective fluid lines. Such a structural element arrangement may, for example, be similar to the structural element 29 shown in FIG. 6.

### LIST OF REFERENCE NUMBERS

1. Structural element
2. Surface
3. Wall
4. Front side
5. Rear side
6. Fluid line
7. Structural element
8. Front side
9. Fluid line
10. Structural element
11. Front side
12. Fluid line
13. Structural element
14 Fluid line
15. Photovoltaic layer
16 Front side
17. Structural element
18. Photovoltaic layer
19. Fluid line
20. Air channel
21. Structural element
22. Thermal insulation layer
23. Front side
24. Rear side
25. Structural element
26. Front side
27. Fluid line
28. Thermal insulation material
29. Structural element
30. Front side
31. Fluid line
32. Thermal insulation material
33. Fluid line
34. Rear side
35. Structural element
36. Protruding section
37. Protruding section
38. Fluid line
39. Thermal insulation material
40. Fluid line
41. Front side
42. Wall

1.-12. (canceled)

13. A structural element, comprising:
a profiled front side;
a rear side;
at least one fluid line;
wherein upon irradiation of the front side by sunlight, a fluid disposed in the fluid line is heated.

14. The structural element according to claim 13, wherein the fluid line is arranged on the front side, or wherein a wall arranged between the front side and the fluid line has a thickness that corresponds at most to double, or one half, or one quarter, or one tenth of a wall thickness of the fluid line.

15. The structural element according to claim 13, wherein the front side or the fluid line is designed, at least in some regions, to absorb or reflect infrared radiation or solar radiation, or wherein the front side or the fluid line is covered, at least in some regions, with a photovoltaic layer.

16. The structural element according to claim 13, further comprising at least one thermal insulation material arranged between the front side and the rear side.

17. The structural element according to claim 13, wherein the front side or the fluid line includes water vapor diffusion permeability, at least in some regions, or includes sound-insulating, at least in some regions.

18. The structural element according to claim 13, wherein the front side comprises a cross-sectional profile with different widely protruding sections.

19. The structural element according to claim 13, wherein the front side comprises a functional surface structure or a dirt-repellent coating at least in some regions.

20. The structural element according to claim 13, wherein the structural element is part of a building or a vehicle.

21. A structural element arrangement, comprising:
a first structural element and a second structural element according to claim 13;
wherein rear sides of the first and second structural elements face each other.

22. A system, comprising:
at least one structural element according to claim 13; and
at least one pumping device to pump a fluid.

23. A system, comprising:
at least one structural element arrangement according to claim 21; and
at least one pumping device to pump a fluid.

24. The system according to claim 22, further comprising:
at least one fluid or a control unit or at least one fluid reservoir or at least one heat exchanger or at least one expansion vessel or at least one safety element or at least one regulating device or at least one sensor or at least one valve or at least one collecting container for condensation or at least one smoke detector.

25. The system according to claim 23, further comprising:
at least one fluid or a control unit or at least one fluid reservoir or at least one heat exchanger or at least one expansion vessel or at least one safety element or at least one regulating device or at least one sensor or at least one valve or at least one collecting container for condensation or at least one smoke detector.

26. The use of a structural element according to claim 13 for producing hot water or to heat a space or to cool a space or to generate electricity or to obtain water or to extinguish a fire.

27. The use of a structural element arrangement according to claim 21 for producing hot water or to heat a space or to cool a space or to generate electricity or to obtain water or to extinguish a fire.

28. The use of a system according to claim 22 for producing hot water or to heat a space or to cool a space or to generate electricity or to obtain water or to extinguish a fire.
